(19) United States
(12) Patent Application Publication
(10) Pub. No.: US 2009/0177648 A1
(43) Pub. Date: Jul. 9, 2009

(54) SYSTEMS AND METHODS FOR ORGANIZING AND MANAGING TRUSTED HEALTH CARE REFERENCE INFORMATION

(76) Inventors: Andrew R. Bond, Lincoln University, PA (US); Joseph A. Lanza, New Haven, CT (US); Philippe F. Simard, Baltimore, MD (US); Pablo R. Perillan, Baltimore, MD (US)

Correspondence Address: JONES DAY, 222 EAST 41ST ST, NEW YORK, NY, 10017, US

(21) Appl. No.: 12/210,816

(22) Filed: Sep. 15, 2008

Related U.S. Application Data
(60) Provisional application No. 60/972,753, filed on Sep. 15, 2007.

(51) Int. Cl. G06F 17/30

(52) U.S. Cl. 707/5; 707/3; 707/E17.108

(57) ABSTRACT

Computer systems, computer readable media, and methods for receiving a search query are provided. Responsive to the search query, data is searched. The data is organized into a plurality of therapeutic categories, each respective category comprising a plurality of documents that relate to the respective category, each document organized into a plurality of predetermined fields of information. Each document is associated with a single therapeutic category. The searching comprises (i) identifying a subset of the plurality of therapeutic categories that pertain to the search query, (ii) identifying a subset of documents that pertain to the search query, and (iii) identifying a subset of fields of information contained in documents in the data that pertain to the search query. The subset of the plurality of therapeutic categories, the subset of documents that pertain to the search query, and the subset of fields of information that pertain to the search query are outputted.

### CROSS REFERENCE TO RELATED APPLICATION

This application claims benefit, under 35 U.S.C. § 119(e), of U.S. Provisional Patent Application No. 60/972,753, filed on Sep. 15, 2007, which is hereby incorporated by reference herein in its entirety.

### FIELD OF THE INVENTION

Systems and methods for organizing and managing trusted health care reference information and retrieval thereof are provided.

### BACKGROUND OF THE INVENTION

There are a vast number of human ailments and diseases and, correspondingly, a large number of medications available to treat such ailments and diseases. In the United States, each such medication is given a national drug code (NDC). Preferably, NDCs are a unique 11-digit 3-segment number that identifies the labeler/vendor, product, and trade package size of a medication listed under Section 510 of the U.S. Federal Food, Drug, and Cosmetic Act. Such medications are classified by indication and given drug classification codes. DCCs are associated with medications based upon the medication's effects on human beings. It is quite possible for several medications to have the same DCC.

Monographs are available for each medication in order to provide physicians and patients with information about such medications. Such monographs are a written description of a medication associated with an NDC. For example, a monograph can include specific field information such as an introduction, a summary, pharmacology, pharmacokinetics, Food and Drug Administration (FDA) approved indications, off-label uses, dosage and administration, adverse effects, overdose, safety data, contraindications, warnings, precautions, drug interactions, efficacy measures, cost comparison, clinical trials, conclusions, recommendations, references, research summaries, to name a few. Monographs are also available for diseases. For example, a monograph on the disease breast cancer may provide treatment options and other structured information about breast cancer.

A monograph contains text which may be stored in a text computer file. Government regulations (OBRA 1990) requires pharmacist to counsel all patients receiving Federal services. Monographs and certain other written information in practice can fulfill the counseling requirement.

A number of commercial vendors provide monographs. For example, Prescribing Reference Inc. (New York, N.Y.), presently provides more than 3,000 drug monographs based on FDA-approved labeling. Another vendor is Wolters Kluwer (Amsterdam, The Netherlands). In addition to providing comprehensive medication information, Wolters Kluwer monographs include comparative charts and tables that illustrate how a given drug compares with similar agents, relevant data references, and the fields “indications,” “adverse reactions,” “dosing,” “clinical trial information,” “pharmacoeconomic information (when available),” “recommendations for adding or replacing formulary drugs,” and “summaries.” A number of other vendors and publishers provide monographs for diseases and for medications.

The wealth of information available for human ailments and diseases and the medications used to treat such ailments and diseases (trusted health care reference information) has given rise to the challenge of providing effective methods for identifying relevant information within such trusted health care reference information and communicating such information to interested parties. Accordingly, what are needed in the art are improved systems and methods for managing trusted health care reference information so that relevant portions of such information can be quickly retrieved and provided to interested parties.

### SUMMARY OF THE INVENTION

Computer systems, computer readable media, and methods for receiving a search query are provided. Responsive to the search query, data is searched. In some embodiments, the data is organized into a plurality of topics, each respective topic comprising a plurality of documents that relate to the respective topic, each document organized into a plurality of predetermined fields of information. Each document is associated with a single topic. The searching comprises (i) identifying a subset of the plurality of topics that pertain to the search query, (ii) identifying a subset of documents that pertain to the search query, and (iii) identifying a subset of fields of information contained in documents in the data that pertain to the search query. The subset of the plurality of topics, a listing of the subset of documents that pertain to the search query (e.g., tiles of such documents, summaries of such documents, or other information that summarizes such documents), and the subset of fields of information that pertain to the search query are outputted. In some embodiments each topic is a therapeutic category.

One aspect provides a computer program product for use in conjunction with a computer system. The computer program product comprises a computer readable storage medium and a computer program mechanism embedded therein for providing medical reference information to a user. The computer program mechanism comprises instructions for receiving a search query. The computer program mechanism further comprises instructions for searching data using the search query. The data is organized into a plurality of topics, each respective topic in the plurality of topics comprising a plurality of documents that relate to the respective topic. Each document in the data organized into a plurality of predetermined fields of information. Each document in the data is associated with a single topic in the plurality of topics. The instructions for searching data comprises the method of (i) identifying a subset of the plurality of topics that pertain to the search query, (ii) identifying a subset of documents that pertain to the search query, and (iii) identifying a subset of fields of information contained in documents in the data that pertain to the search query. The computer program mechanism further comprises instructions for separately outputting (i) the subset of the plurality of topics, (ii) a listing of the subset of documents that pertain to the search query (e.g., tiles of such documents, summaries of such documents, or other information that summarizes such documents), and (iii) the subset of fields of information that pertain to the search query to a user, a display, a user-accessible computer readable media, or a computer.

In some embodiments, the instructions for separately outputting further comprises ranking the subset of documents based on relevance to the search query and displaying the subset of documents ranked based on relevance to the search query. In some embodiments, the data is trusted health care reference information and each document in the data is a monograph pertaining to a topic in the plurality of topics. In some embodiments, a monograph in the data describes a drug that is used to treat a disease. In some embodiments, a monograph in the data describes a disease. In some embodiments, the plurality of predetermined fields of information comprises at least two, three, four, five, six, seven, eight, nine, or ten fields from the group consisting of an introduction field, a summary field, a pharmacology field, a pharmaco-kinetics field, an Food and Drug Administration (FDA) approved indications field, an off-label uses field, a dosage and administration field, an adverse effects field, an overdose field, a safety data field, a contraindications field, a warnings field, a precautions field, a drug interactions field, an efficacy measures field, a cost comparison field, a clinical trials field, a conclusions field, a recommendations field, a references field, and a research summaries field. In some embodiments, the identifying a subset of documents that pertain to the search query comprises scoring each respective document in the data for a number of occurrences of the search term in the respective document thereby obtaining a document score, wherein an instance of the search term in a header of the respective document is given more weight in the document score than an instance of the search term in the body of the respective document. In some embodiments, each document in the subset of documents is in a topic in the plurality of topics. In some embodiments, a document in the subset of documents is not in a topic in the plurality of topics.

Another aspect provides a computer system comprising a processor and a memory, coupled to the processor. The memory stores instructions for receiving a search query. The memory further stores instructions for searching data using the search query. The data is organized into a plurality of topics, each respective topic in the plurality of topics comprising a plurality of documents that relate to the respective topic. Each document in the data organized into a plurality of predetermined fields of information. Each document in the data is associated with a single topic in the plurality of topics. The instructions for searching data comprises the method of (i) identifying a subset of the plurality of topics that pertain to the search query, (ii) identifying a subset of documents that pertain to the search query, and (iii) identifying a subset of fields of information contained in documents in the data that pertain to the search query. The memory further stores instructions for separately outputting (i) the subset of the plurality of topics, (ii) the subset of documents that pertain to the search query (e.g., tiles of such documents, summaries of such documents, or other information that summarizes such documents), and (iii) the subset of fields of information that pertain to the search query to a user, a display, a user-accessible computer readable media, or a computer.

Another aspect provides a method in which a search query is received and data is searched using the search query. The data is organized into a plurality of topics, each respective topic in the plurality of topics comprising a plurality of documents that relate to the respective topic. Each document in the data organized into a plurality of predetermined fields of information. Each document in the data is associated with a single topic in the plurality of topics. The searching of the data comprises the method of (i) identifying a subset of the plurality of topics that pertain to the search query, (ii) identifying a subset of documents that pertain to the search query, and (iii) identifying a subset of fields of information contained in documents in the data that pertain to the search query. The subset of the plurality of topics, a listing of the subset of documents that pertain to the search query (e.g., tiles of such documents, summaries of such documents, or other information that summarizes such documents), and the subset of fields of information that pertain to the search query are separately outputted to a user, a display, a user-accessible computer readable media, or a computer.

### BRIEF DESCRIPTION OF THE DRAWINGS

FIG. 1 illustrates a computer system for organizing and managing trusted health care reference information.

FIG. 2 illustrates a user interface for the Medicos reference download application (MRDA) which provides an improved way of organizing and managing trusted health care reference information in which any publisher can securely deliver their content via the MRDA to an individual user's personal library. In the example of the trusted reference information illustrated in FIG. 2, the MRDA comes preloaded with the monthly prescribing reference (MPR) pharmacopeia.

FIG. 3 illustrates an exemplary user interface of FIG. 2 after a user has entered the search term “migraine” into the user interface of FIG. 2.

FIGS. 4A-4C illustrates the features of an integrated spell checker that provides alternative spelling for search queries.

FIG. 5 illustrates therapeutic categories that are available in the exemplary user interface.

FIG. 6 illustrates a pharmacopeia index view of the exemplary user interface.

FIGS. 7A-7D illustrate steps taken to obtain monograph search results in which products in the same therapeutic class can be quickly viewed by clicking on a “Section” view.

FIGS. 8A-8C illustrate a web interface in which users can search a content management system on a remote computer.

FIG. 9 illustrates a web interface in which users can navigate a publisher's content using search tools and content clustering that follows a particular publisher's own format.

FIG. 10 illustrates clipboard in a web interface in which users can track and compare drugs.

FIG. 11 illustrates the use of the clipboard of FIG. 10 in which a comparison of the prescribing information of three drugs, ACCOLATE, DARVON, and MAALOX, is provided.

Like reference numerals refer to corresponding parts throughout the several views of the drawings.

### DETAILED DESCRIPTION

The present invention provides systems and methods for organizing and managing trusted health care reference information such as a plurality of drug monographs. One embodiment of the present invention is a MEDICOS download application (MRDA) 44. Another embodiment of the present invention is a MEDICOS Internet server application (MISA) 46. Using embodiments of the present invention, any publisher can securely deliver their content via to an individual user's personal library. As an example of trusted reference information, the MRDA comes preloaded with the Monthly Prescribing Reference (MPR).

### EXEMPLARY COMPUTER IMPLEMENTATION

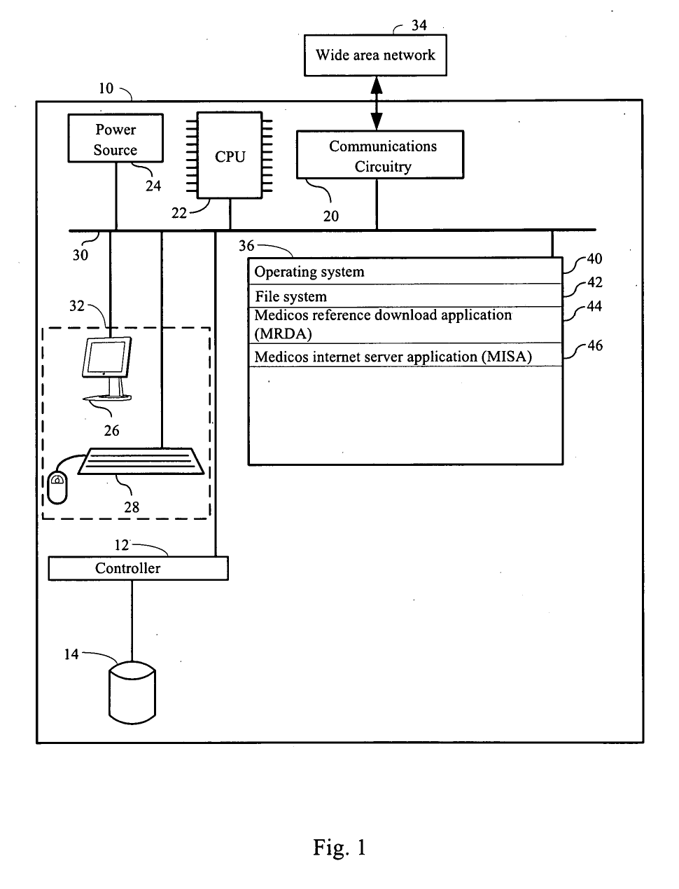

Now that an overview of one embodiment of the present invention has been described, an exemplary system that supports the functionality of embodiments of the application will be described in conjunction with FIG. 1. The system is preferably a computer system 10 having:

a central processing unit 22;

a main non-volatile storage unit 14, for example a hard disk drive, for storing software and data, the storage unit 14 controlled by storage controller 12;

a system memory 36, preferably high speed random-access memory (RAM), for storing system control programs, data, and application programs, comprising programs and data loaded from non-volatile storage unit 14; system memory 36 may also include read-only memory (ROM);

a user interface 32, comprising one or more input devices (e.g., keyboard 28) and a display 26 as well as other input and output devices (e.g., a mouse);

a network interface card 20 for connecting to any wired or wireless communication network 34 (e.g., a wide area network such as the Internet);

an internal bus 30 for interconnecting the aforementioned elements of the system; and

a power source 24 to power the aforementioned elements.

Operation of computer 10 is controlled primarily by operating system 40, which is executed by central processing unit 22. Operating system 40 can be stored in system memory 36. In a typical implementation, system memory 36 includes:

file system 42 for controlling access to the various files and data structures used by the present invention;

a Medicos download application (MRDA) 44 for organizing and managing trusted health care reference information; and

a Medicos Internet server application (MISA) 46 for searching trusted health care reference information.

As illustrated in FIG. 1, computer 10 comprises a Medicos download application (MRDA) 44 and a Medicos Internet server application (MISA) 46 as well as other data structures and/or computer program modules. In some embodiments, some component data structures and/or modules are stored on computer systems that are not illustrated by FIG. 1 but that are addressable by wide area network 34. Thus, it will be appreciated that many of the data structures and/or modules illustrated in FIG. 1 can be located on one or more remote computers. In some embodiments, some of the data structures and/or program modules illustrated in FIG. 1 are on a single computer (computer 10) and in other embodiments they are hosted by several computers (not shown). Any arrangement of the data structures and/or computer program modules illustrated in FIG. 1 on one or more computers is within the scope of the present invention so long as these components are addressable with respect to each other across network 34 or other electronic means (e.g., wireless means). Thus, the present invention fully encompasses a broad array of computer systems.

In some embodiments the trusted health care reference information comprises a plurality of monographs. Each monograph comprises a plurality of fields. Each monograph is organized into a plurality of topics. Each topic can alternatively be referred to as a chapter. Thus, in some embodiments trusted health care reference information that is queried by MRDA 44 and/or MISA 46 is organized set of topics (sections), each section comprising a plurality of monographs that relate to the section, and each such monograph comprising a plurality of fields. In some embodiments, the set of topics (sections) in the trusted health care reference information comprises: (i) allergic disorders, (ii), cardiovascular system, (iii) central nervous system, (iv) dental, (v) dermatological disorders, (vi) diagnostic agents, (vii) ear disorders, (viii) endocrine system, (ix) eye disorders, (x) gastrointestinal tract, (xi) immune system, (xii) infections & infestations, (xiii) musculoskeletal disorders, (xiv) neoplasms, (xv) nutrition, (xvi) Ob/Gyn, (xvii) pain & pyrexia, (xviii) poisoning & drug dependence, (xix) respiratory tract, and (xx) urogentical system. In some embodiments, the fields in a monograph comprises some combination of the following fields: a section classification (e.g., immune system→immunization), a manufacturer, a legal classification (e.g., over the counter, prescription, etc.), a pharmacological class (e.g., mumps vaccine), a generic description (e.g., mumps virus vaccine live; contains gelatin, neomycin, human albumin; preservative free), an indication (e.g., mumps immunization), an adults and children dosage (e.g., for less than 12 months of age: not recommended; each does is 0.5 mL, give by SC injection into upper outer arm), contraindications (e.g., defer in moderate or severe active respiratory or other febrile infection), precautions (e.g., egg allergy; thrombocytopenia), interactions (e.g., may get suboptimal response with immunosuppresants), adverse reactions (e.g., fever, syncope, vasculitis, pancreatitis, etc.), and how supplied (e.g., single-does vials).

One aspect of the present invention comprises computer systems that can carry out any of the methods, or parts thereof, disclosed in this application. Another aspect of the present invention comprises computer program products that can carry out any of the methods, or parts thereof, disclosed in this application.

### EXEMPLARY INTERFACES

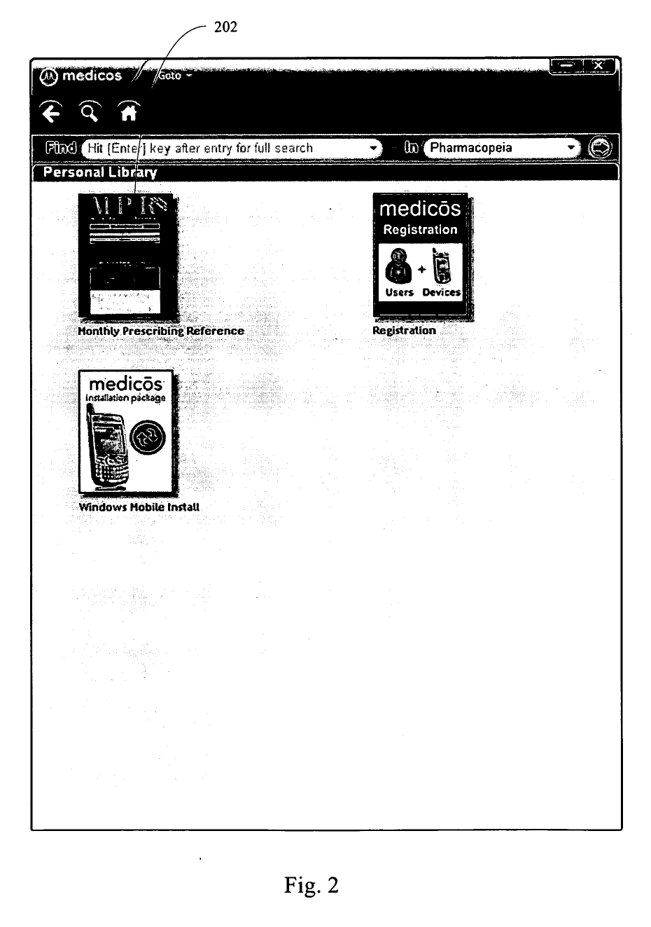

Now that an overview of an exemplary computer system has been presented, an exemplary interface will be presented in conjunction with FIGS. 2-11.

FIG. 2 illustrates the MRDA home page in accordance with an embodiment of the present invention. The MRDA provides a better way of organizing and managing trusted health care reference information. Any publisher can securely deliver their content via the MRDA to an individual user's personal library after a user registers to receive or access desired content via the “Medicos registration” link (FIG. 2) the permits the user to securely set up an account. Conventional account setup methods with any suitable encryption are applicable in this regard. User may also access the desired information using a wireless mobile device by installing the application software on a mobile device (e.g., Windows mobile install, FIG. 2). As an example of trusted reference information the MRDA comes preloaded with the Monthly Prescribing Reference (MPR) pharmacopeia 202.

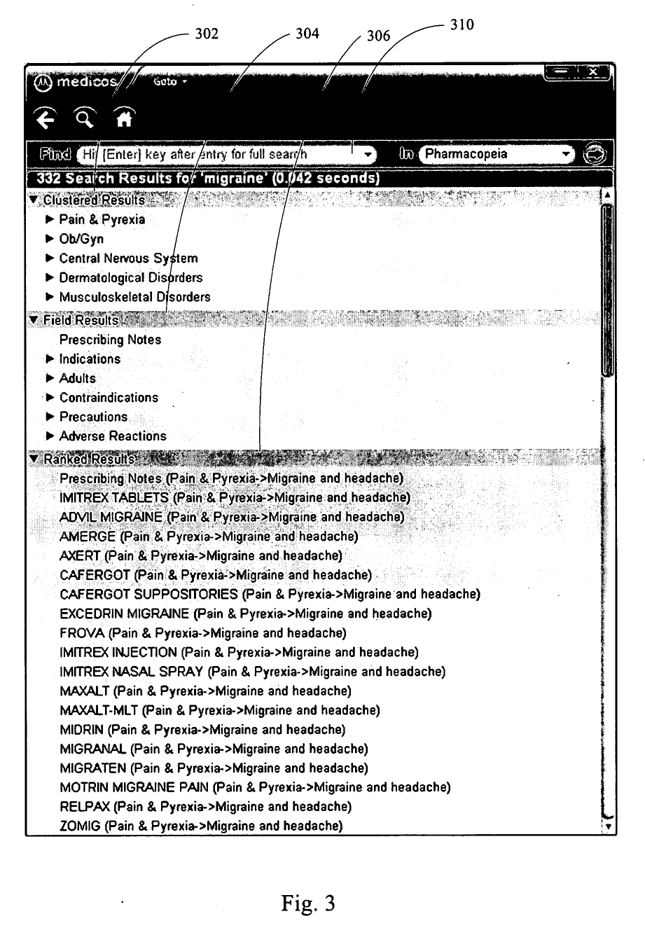

FIG. 3 illustrates how the MRDA user interface is configured so that it provides the user with trusted reference information. A user types in a term in search box 310 and results are displayed in several different complementary fashions as illustrated in FIG. 3. Whether a user is connected or disconnected from the Internet, the results of a typical search are displayed in a few milliseconds in both desktop and mobile environments. As illustrated in FIG. 3, the user's search expression is used to search through managing trusted health care reference information and identify search results.

As discussed above, the trusted health care reference information provides organized hierarchical information. First, the trusted health care reference information is organized into a plurality of topics (chapters). In some embodiments, the trusted health care reference information comprises more than five topics, more than ten topics, more than one hundred topics, or between five and five thousand topics. Each topic comprises a plurality of monographs. Each monograph in a topic is related to the topic. For example, each of the monographs for the topic “pain & pyrexia” relate to pain or pyrexia. At least some of the monographs for the topic “pain & pyrexia” can be monographs for drugs that treat a pain or a pyrexia indication. At least some of the monographs for the topic “pain & pyrexia” can be monographs for pain or pyrexia indication themselves. Each monograph in each of the topics contains specialized sections that are termed “fields.” Examples of fields (e.g., indications, contradindications, etc.) have been described above. In some embodiments, each topic is arranged into a plurality of subtopics. In such embodiments, each respective monograph in a subtopic related to the subtopic.

Advantageously, the present invention takes advantage of the above-identified structure of the trusted health care reference information to identify search results relevant to the user's search query for at least three hierarchical levels: topics, monographs, and fields. In some embodiments there are more than three hierarchical levels because each of the topics is arranged into subtopics. FIG. 3 illustrates this, for example, by showing a list of topics under “clustered results,” each with a left arrow that permits the user to drill down in to the subtopics by clicking the arrow. Clustered results 302 show those topics that relate to the user's query. Thus, as used herein the term “clustered results” means a subset of the plurality of topics that are available in the trusted health care reference information. In some embodiments, the topics that are reported in the clustered results are those topics that contain the most number of instances of the search expression. For example, consider the topic Ob/Gyn. In some embodiments, when a user enters a search query at prompt 310, a search of each of the monographs in the Ob/Gyn topic is performed to obtain a count. In some embodiments, this count represents the number of instances that the search query is present in the monographs in the Ob/Gyn topic. In some embodiments, this count represents the number of monographs in the Ob/Gyn topic that contain the search expression. In some embodiments, this count represents the number of times that the search query is found in a first predetermined number of words of monographs in the Ob/Gyn topic. In some embodiments, this count is normalized by the total word count of the monographs in the Ob/Gyn topic or the number of monographs in the Ob/Gyn topic. In some embodiments, each instance of a search expression in a monograph is weighted based on where it appears in the monograph. For example, in some embodiments, in some embodiments an instance of the search expression is given more weight if it appears in the title to a field as opposed to in a caption to a figure or in body text within the monograph. The count is used to rank the Ob/Gyn topic relative to the count that is obtained for each of the other topics in the trusted health care reference information. In some embodiments, only a predetermined number of topics are displayed in clustered results 302. For example, in some embodiments, only the topics corresponding to the top three score, the top four score, the top five scores, the top six scores, the top seven scores or the top eight scores are reported in clustered results panel 302. The scoring of topics against the one or more terms of the search query can be done by any suitable scoring approach, such as those conventionally known in the art. In some embodiments, the only limits on the number of topics that is displayed in clustered results panel 302 are that (i) the number of topics displayed is a subset of the total number of topics in the trusted health care reference information and (ii) that each topic that is displayed have a count or score that exceeds a predetermined threshold. The above-identified methods for identifying a subset of the total number of topics that relate to a search query are merely exemplary and those of skill in the art will recognize that variations and permutations of the above-identified concepts can be used to identify a subset of topics in the trusted health care reference information that relate to a search query.

In some embodiments, a search for subtopics that relate to a user's query is performed. In such embodiments, when a user selects a topic in clustered results 302, only those sub-topics pertaining to the selected topic that contain monographs that have at least a predetermined amount of relevance to the search expression are displayed, e.g., as determined by any suitable scoring method.

Using FIG. 3 as a guide, the second hierarchical level of information that is independently provided in response to a search query are field results 304. In some embodiments, field results 304 are fields in any monograph in the trusted health care reference information that contain the search expression. In some embodiments, there is no requirement that the field results 304 be fields in monographs in topics that are displayed in clustered results 302. Thus, in some embodiments, the query of the field results is independent of the identification of the topics displayed in clustered results panel 302. In some embodiments, field results are identified by independently counting the number of instances of the search expression in each field in each monograph in the trusted health care reference information. In some embodiments, field results are identified by independently counting the number of instances of the search expression in each field in each monograph in only those topics in the trusted health care reference information that appears in clustered results 302. In some embodiments, each respective field in each monograph considered by the search query is scored based on the number of instances of the search query in the respective field. In some embodiments only the first predetermined number of words in a search query is searched for the search query. In some embodiments, the number of times a search query is found in a given field is normalized by the number of words in the search query. The search query count of each field is used to identify those fields that should be displayed in field results 304. For example, consider the case where the user enters the search query “migraine.” A search is performed on each field in each monograph and field results are identified by independently counting the number of instances of the search expression in each field in each monograph in the trusted health care reference information (FIG. 3). Thus, for example, the term “migraine” may be found in the indications field of a monograph on the drug ADVIL. Since the vast majority of the fields in the monographs that are searched do not contain the search expression, the identification of even just one instance of the search expression in a field is sufficient to cause that field to by reported in the field results 304 in some embodiments. Rather than displaying the entire contents of the indications field of the ADVIL® monograph, the field identifier “Indications” is displayed in field results 304. When a user clicks on the “Indications” tab in field results 304, a list of monographs that contain the term “migraine” in their “Indications” field are displayed. In one example, when the search expression “migraine” is entered, and the user clicks on the “Indications” field in search results 304, a list of monographs that each contain the word “migraine” in their Indications field may be displayed including, but not limited to the monographs for IMITREX® tablets, ADVIL® migraine tablets, AMERGE®, AXERT®, CAFERGOT®, to name a few.

Advantageously, the systems and methods of the present invention return yet another type of information in response to a query provide at field 310: a list of monographs 306 that contain the search term. In some embodiments, only those monographs that are in a topic clustered results 302 and that contain the search term are listed. In some embodiments, any monograph that contains the search term is listed in results 306 regardless of whether that monograph is in the clustered results panel 302. In some embodiments, only those monographs that achieve a certain score based on the number of times they contain the search expression are listed in panel 306. Such scores can be based on searching a first number of predetermined number of words in each monograph, normalization of the total number of instances the search expression is found anywhere in a respective monograph by the word count of the respective monograph or by other suitable scoring techniques such as those known in the art.

The combined results illustrated in FIG. 3 responsive to a user search query provide pertinent information stored in the trusted health care reference information at three different levels: topics, fields, and monographs. Thus, at a single glance a user can decide whether to drill into topics in panel 302 in order to find relevant monographs, to drill into specific monographs based on field results 304, or to review the monographs that have been ranked based on their relevance to the search expression. This technique for searching trusted health care reference information can be extended to querying other forms of content. Any content that has been structured into a set of topics (chapters, sections), where each respective topic contains a plurality of documents relevant to the respective topic and each such document contains predetermined fields of information. There is no requirement that each such document include all of the predetermined fields of information.

Referring to FIG. 3, one aspect provides a method in which data (e.g., trusted health care reference information) is searched using a search query. The data is organized into a plurality of topics, each respective topic in the plurality of topics comprising a plurality of documents that relate to the respective topic. Each document in the data is organized into a plurality of predetermined fields of information. Each document in the data is associated with a single topic in the plurality of topics. The searching data comprises the method of performing any combination of the following: (i) identifying a subset of the plurality of topics that pertain to the search query, (ii) identifying a subset of documents that pertain to the search query, and/or (iii) identifying a subset of fields of information contained in documents in the data that pertain to the search query. Depending on which searching was perform, some combination of the following is outputted: (i) the subset of the plurality of topics, (ii) the subset of documents that pertain to the search query (e.g., tiles of such documents, summaries of such documents, or other information that summarizes such documents as illustrated, for example, in panel 306 of FIG. 3), and/or (iii) the subset of fields of information that pertain to the search query to a user, a display, a user-accessible computer readable media, or a computer. In some embodiments, the searching comprises: (i) identifying a subset of the plurality of topics that pertain to the search query and (ii) identifying a subset of documents that pertain to the search query and the outputting comprises outputting: (i) the subset of the plurality of topics and (ii) a listing of the subset of documents that pertain to the search query to a user, a display, a user-accessible computer readable media, or a computer. In some embodiments, the searching comprises: (i) identifying a subset of documents that pertain to the search query and (ii) identifying a subset of fields of information contained in documents in the data that pertain to the search query and the outputting comprises outputting: (i) a listing of the subset of documents that pertain to the search query, and (ii) the subset of fields of information that pertain to the search query to a user, a display, a user-accessible computer readable media, or a computer. In some embodiments, the searching comprises: (i) identifying a subset of the plurality of topics that pertain to the search query and (ii) identifying a subset of fields of information contained in documents in the data that pertain to the search query and the outputting comprises outputting: (i) the subset of the plurality of topics and (ii) the subset of fields of information that pertain to the search query to a user, a display, a user-accessible computer readable media, or a computer.

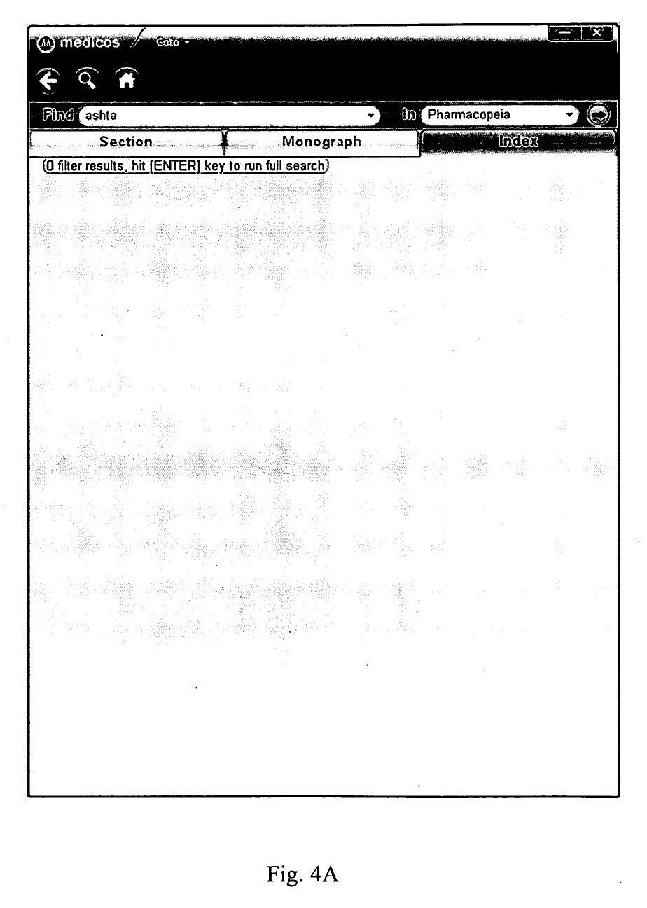

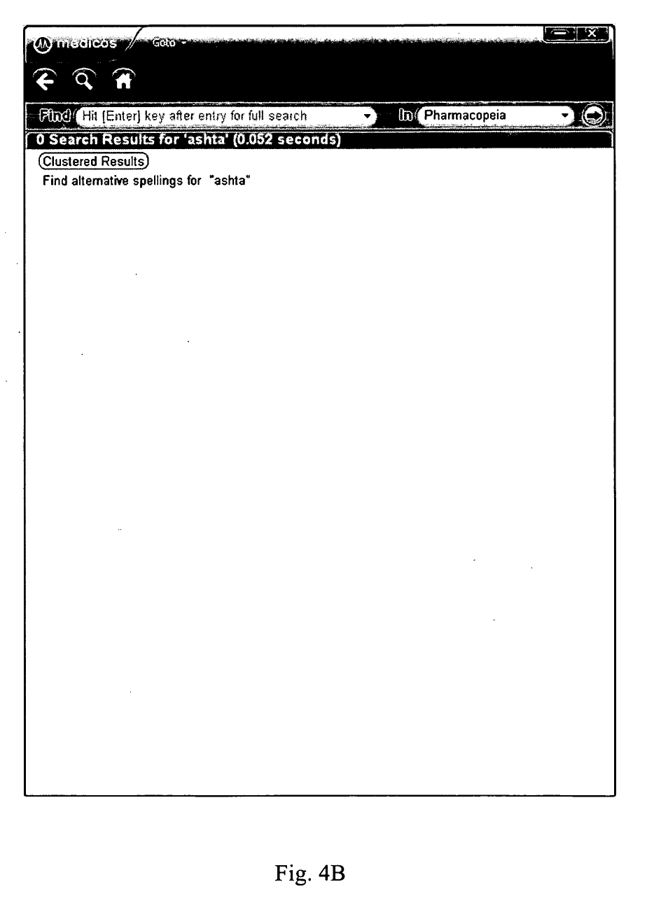

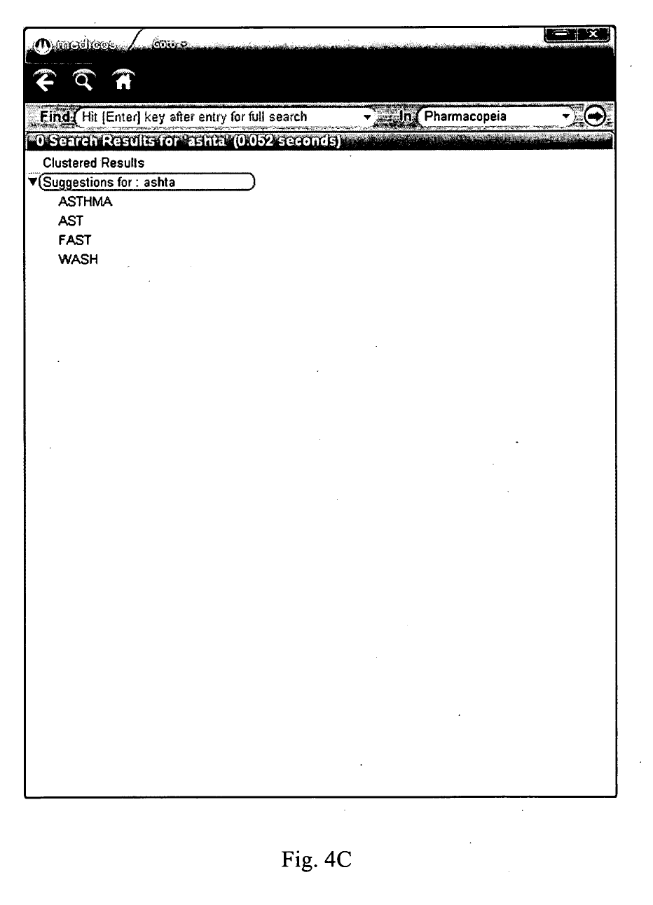

Referring to FIGS. 4A-4C, the MRDA advantageously provides a fully automated spell checker that provides alternative spellings and search queries. This spell check functionality can be provided by any suitable algorithm, such as those conventionally known in the art. Advantageously, the MRDA features multi-platform compatibility. It is currently available for both Microsoft Windows PCs and Microsoft Mobile Devices (PocketPC and Windows Mobile). Furthermore, advantageously, the MRDA is configured to provide automatic updates in which all proprietary content and added MRDA functionality is periodically, securely, and automatically updated for all users.

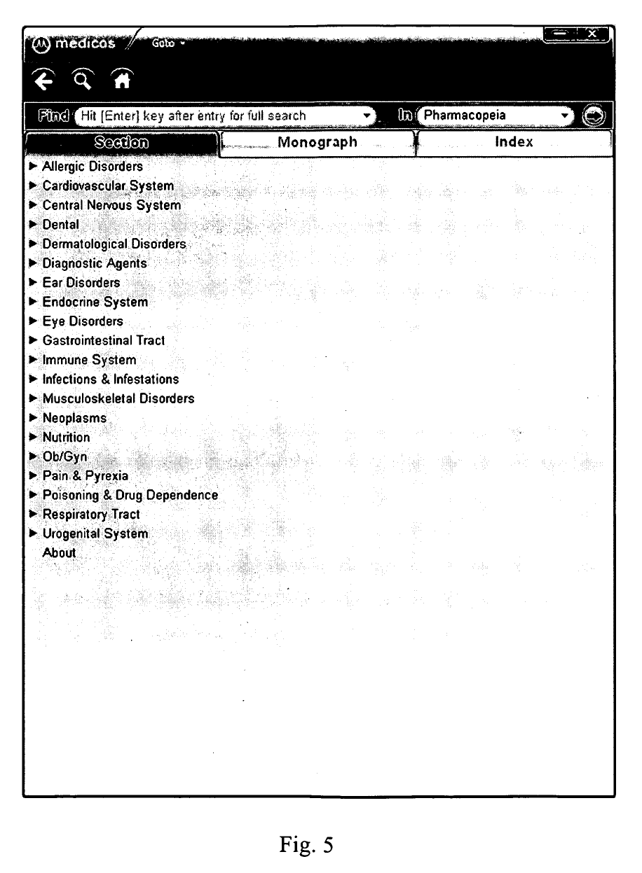

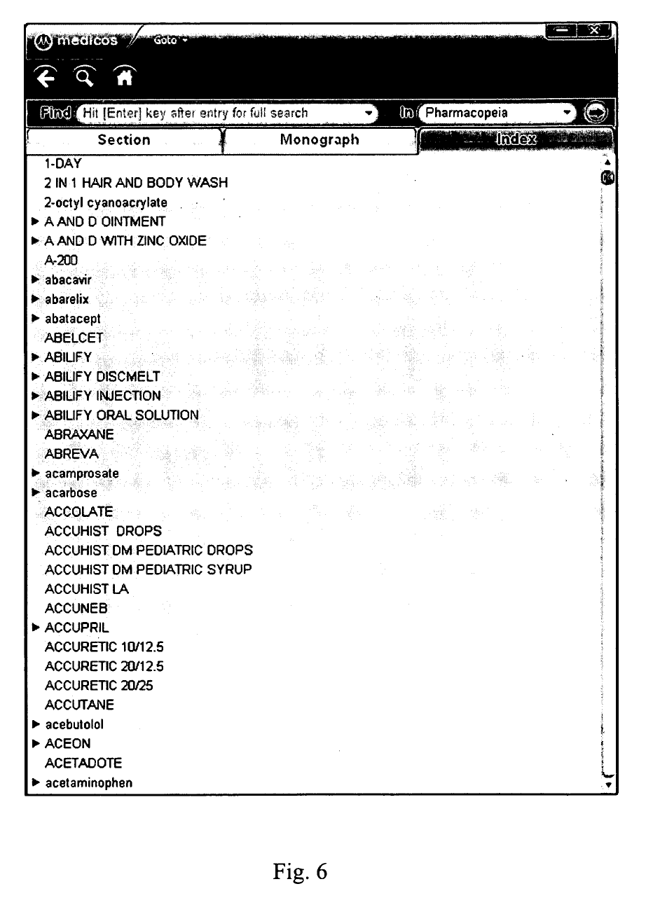

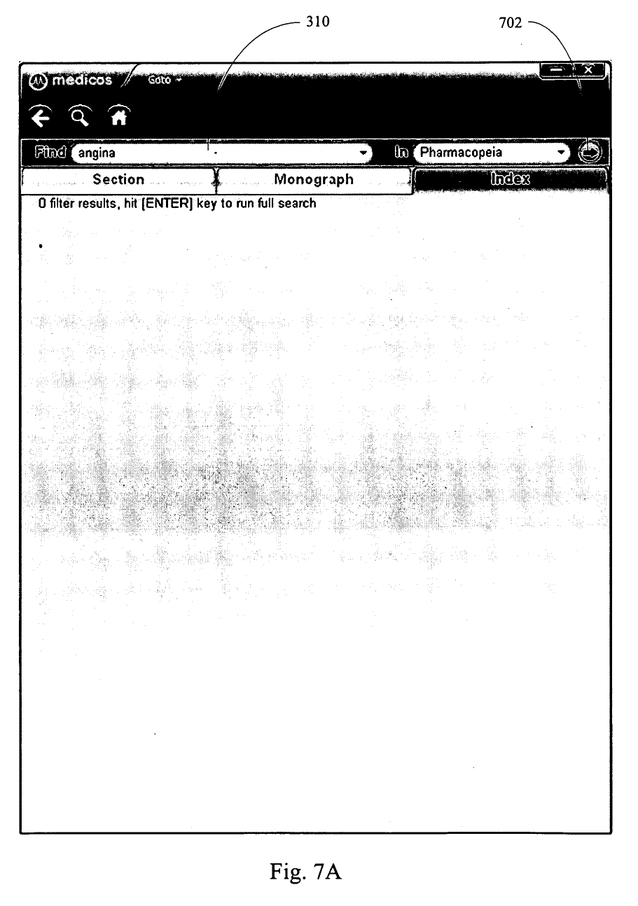

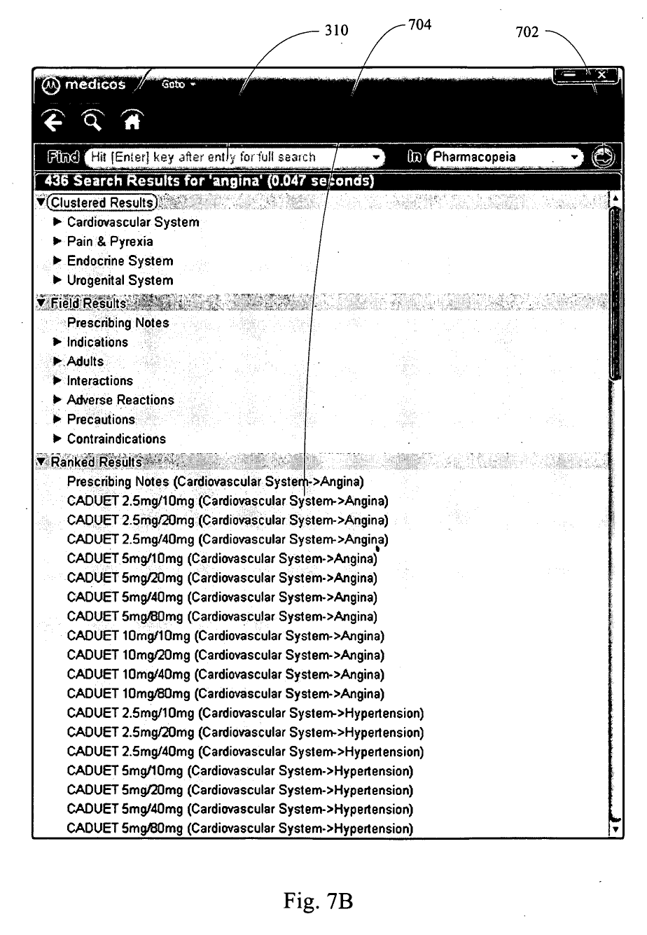

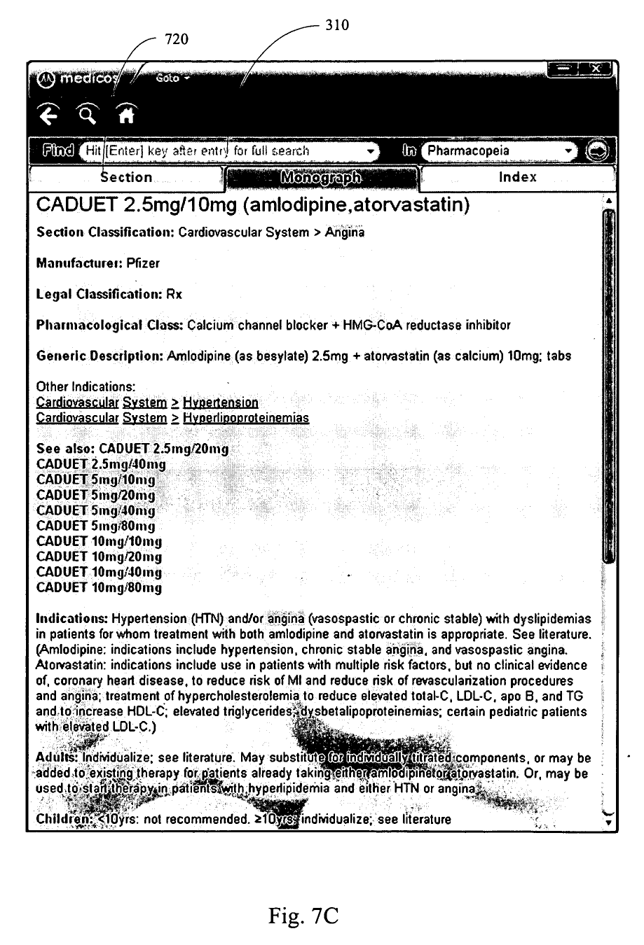

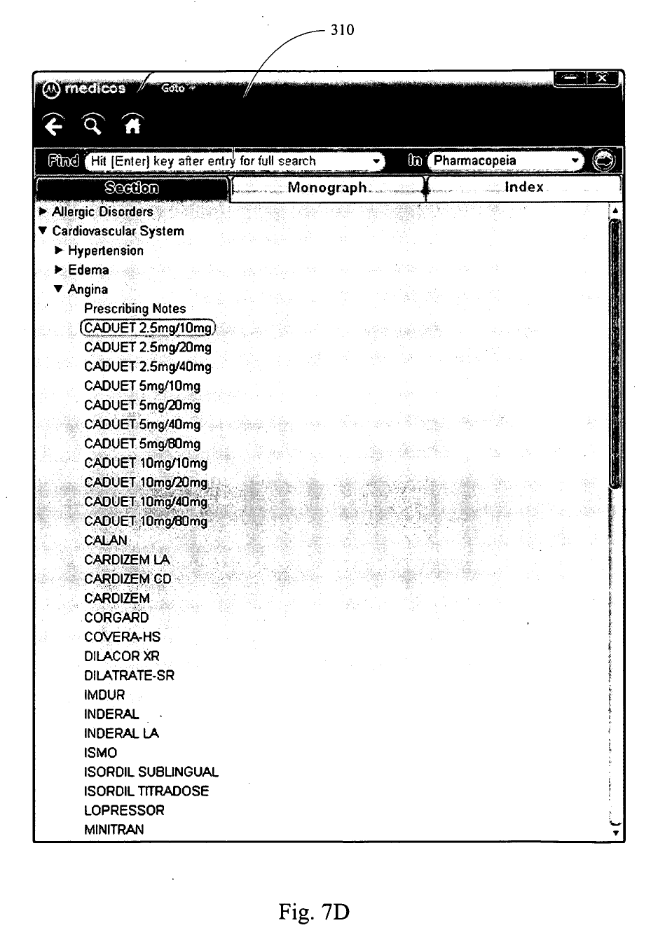

In some embodiments, the MPR pharmacopeia includes such features as (i) the twenty therapeutic categories (topics) illustrated in FIG. 5 along with 109 corresponding sub-categories; (ii) fully searchable database with linked cross references; and (iii) an index view in which results displayed are filtered by manufacturer or pharmacological class as illustrated in FIG. 6. The panel displayed in FIG. 7 may be reached by entering no providing an empty search query into query box 310 of FIG. 3 or by other suitable navigation means. Referring to FIGS. 7A-7D, in some embodiments, the pharmacopeia further includes such features as monographs with search results highlighted. In FIG. 7A, a user types in the search expression “angina” into search box 310 and then clicks on arrow 702. In response, 436 search results are returned as illustrated in FIG. 7B. If the user clicks on “CADUET 2.5 mg/10 mg (Cardiovascular System→Angina)” 704, the results in FIG. 7C are returned. Advantageously, in the results of FIG. 7C, each instance of the original search term “angina” is highlighted. Using the interface illustrated in FIG. 7B, a user can find a particular drug, as illustrated in FIG. 7C, and then quickly view other products in the same therapeutic class by clicking the Section view 720 to get the results illustrated in FIG. 7D. Thus, in this way, the MRDA advantageously provides methods for rapidly finding therapeutic alternatives.

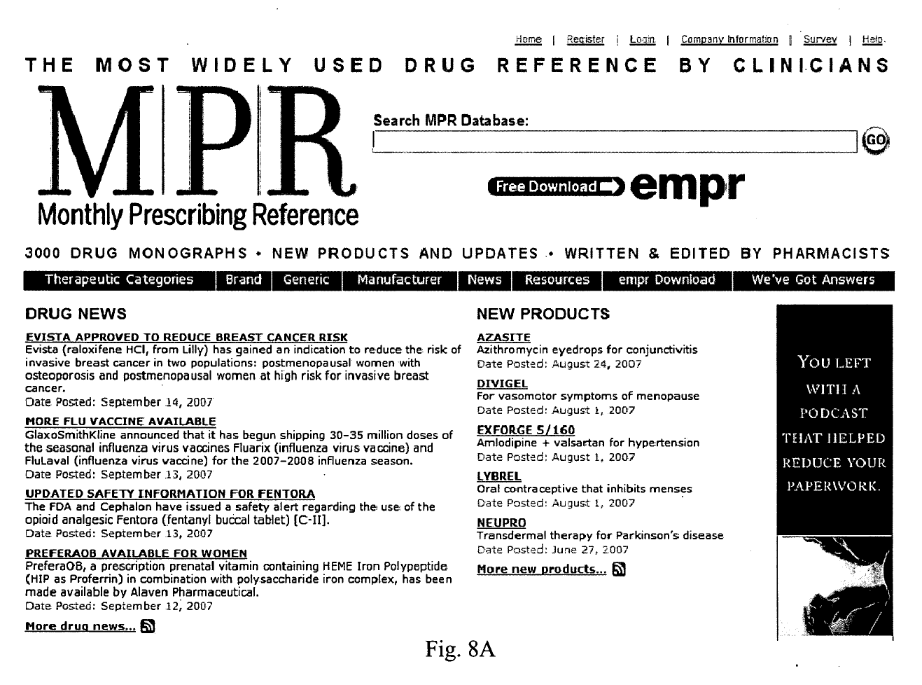

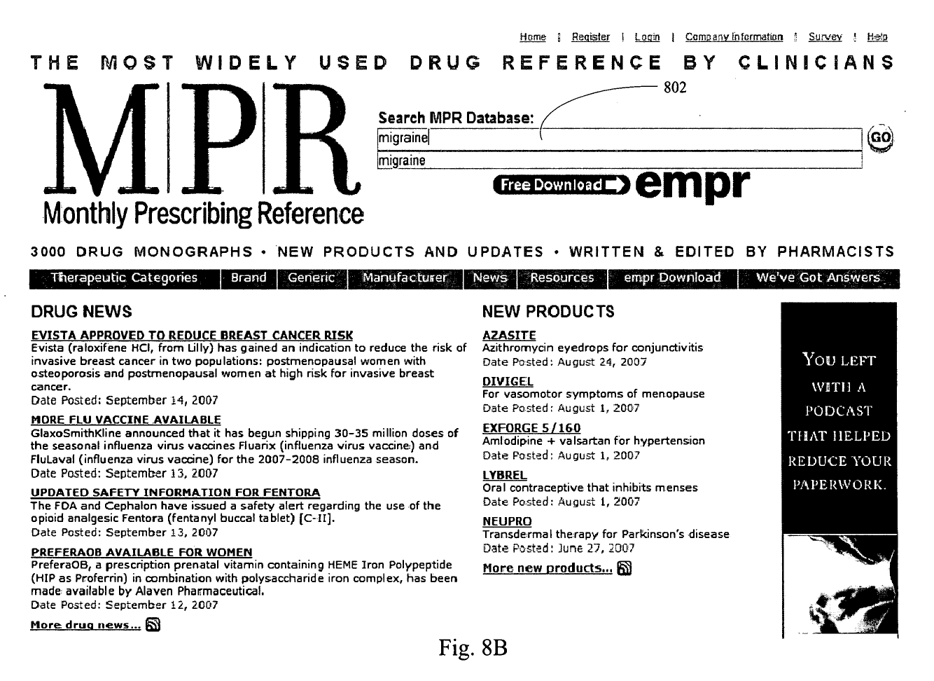

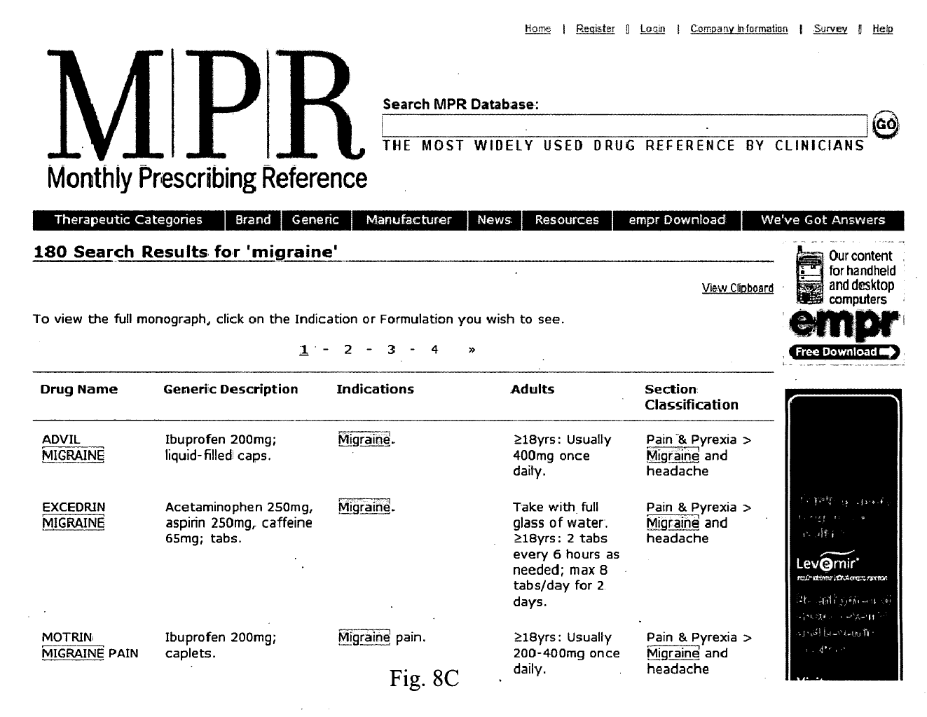

Referring to FIG. 8A, the Medicos internet server application (MISA) provides a web interface that runs off of a formulary server which is the core of a fully integrated content management system (CMS). Visitors to the proprietary website have full access to publishers' content in a fully searchable format. All publishers' content can be locked down and displayed in adherence with their individual copyright policies. Referring to FIG. 8B, the MISA provides a query box 802 that allows a user to enter a search term, for example, the search term “migraine”. As shown in FIG. 8C, in response, 180 fully integrated search results for “migraine” are provided. Navigating a publisher's content via this web interface is intuitive because of highly developed search tools and content clustering that follows a particular publisher's own format.

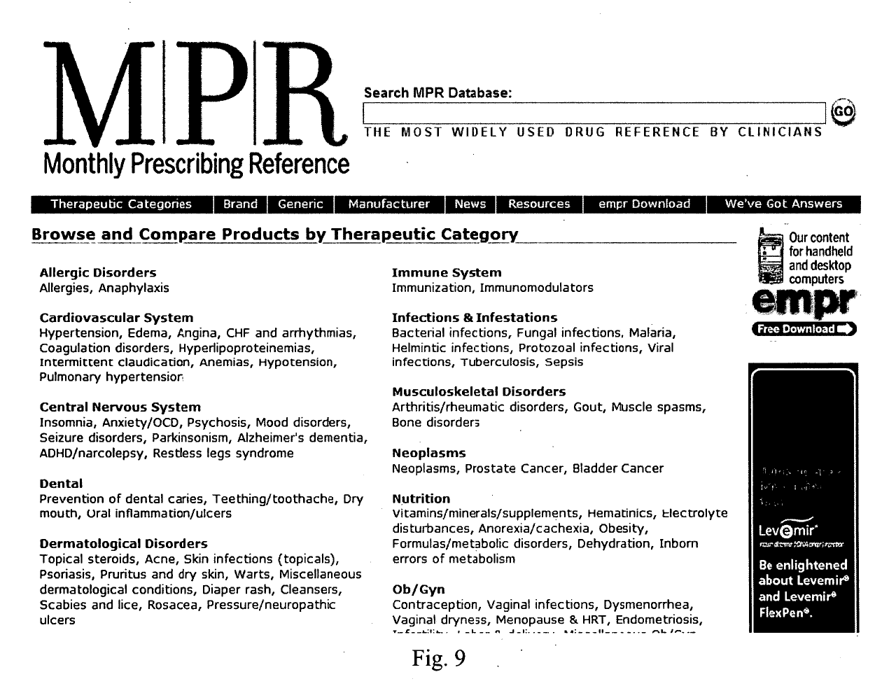

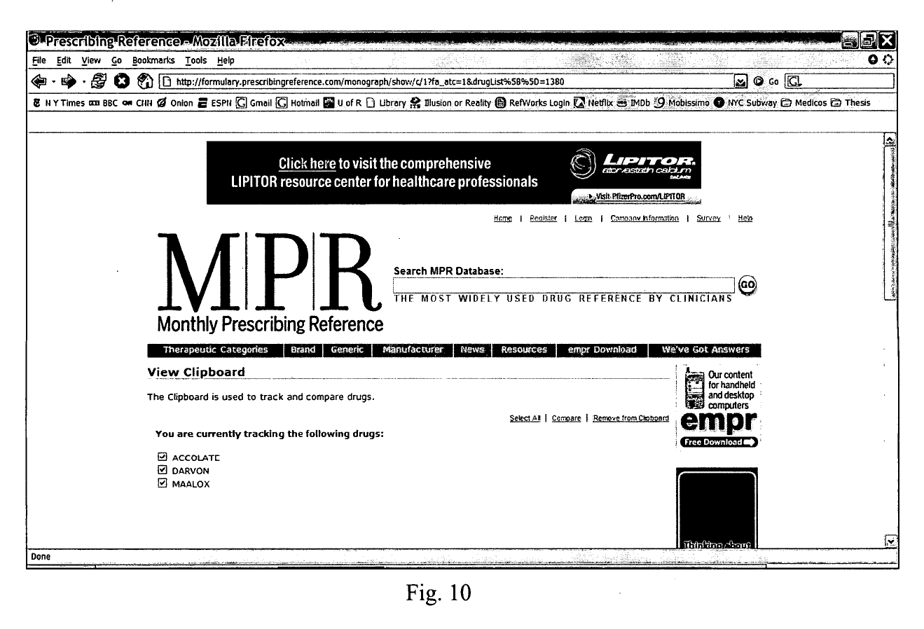

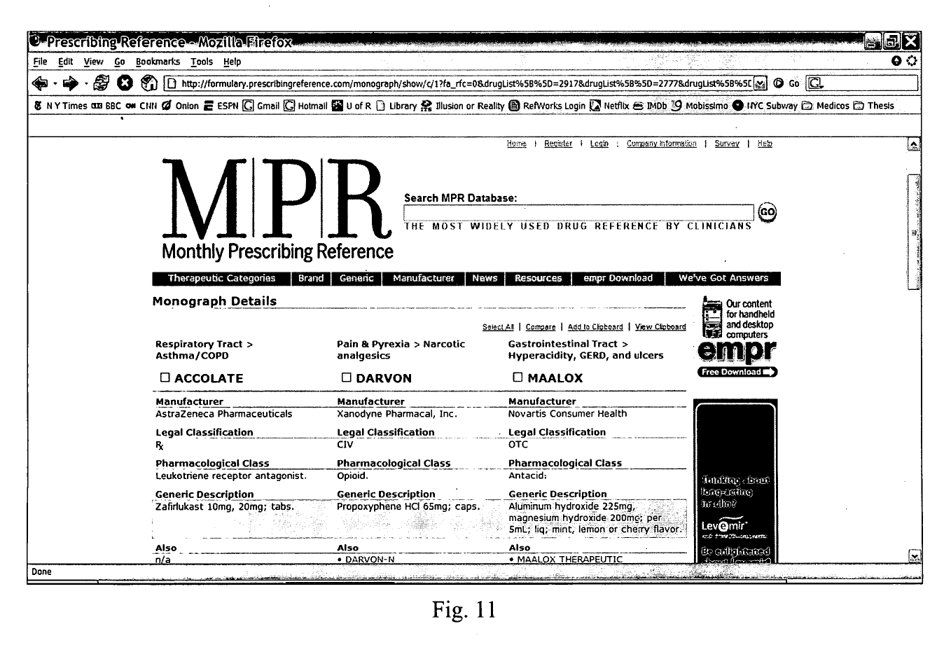

As illustrated in FIG. 9, users can browse the drug database that supports the MISA via therapeutic categories. One of the core functionalities of the monthly prescribing reference (MPR) website apart from the full searchability of the pharmacopeia is the drug clipboard. From this clipboard a user can track new developments in a particular drug's prescribing information or compare the prescribing notes of multiple drugs. The drug clipboard is illustrated in FIG. 10. FIG. 11 illustrates an instance of the clipboard in which the prescribing information for three drugs, ACCOLADE®, DARVON®, and MAALOX® is presented and compared. A user may navigate to the panels illustrated in FIG. 8 through 11 using the monthly prescribing option 202 of FIG. 2.

The results of any the methods disclosed herein can be outputted to a user, a display, a user-accessible computer readable media, or a computer.

### COMPUTER AND COMPUTER PROGRAM PRODUCT IMPLEMENTATIONS

The present invention can be implemented as a tangible computer program product that comprises a computer program mechanism embedded in a computer readable storage medium. For instance, the computer program product could contain the program modules shown in FIG. 1. These program modules may be stored in any suitable computer readable storage medium such as, but not limited to a CD-ROM, DVD, magnetic disk storage medium, electronic storage medium (e.g., flash memory), or any other tangible computer readable storage medium. Further, any of the methods of the present invention can be implemented in one or more computers. Further still, any of the methods of the present invention can be implemented in one or more computer program products. Some embodiments of the present invention provide a computer program product that encodes any or all of the methods disclosed herein. Such methods can be stored in any suitable computer readable storage medium such as, but not limited to a CD-ROM, DVD, magnetic disk storage medium, electronic storage medium (e.g., flash memory), or any other tangible computer readable storage medium. Such methods can also be embedded in permanent storage, such as ROM, one or more programmable chips, or one or more application specific integrated circuits (ASICs). Such permanent storage can be localized in a server, 802.11 access point, 802.11 wireless bridge/station, repeater, router, mobile phone, or other electronic devices. Such methods can also be distributed electronically, via the Internet or otherwise.

Some embodiments of the present invention provide a tangible computer program product that contains any or all of the program modules or data structures shown in FIG. 1. These program modules can be stored in any suitable computer readable storage medium such as, but not limited to, a CD-ROM, DVD, magnetic disk storage medium, electronic storage medium, or any other computer readable storage medium. The program modules can also be embedded in permanent storage, such as ROM, one or more programmable chips, or one or more application specific integrated circuits (ASICs). Such permanent storage can be localized in a server, 802.11 access point, 802.11 wireless bridge/station, repeater, router, mobile phone, or other electronic devices. The software modules in the computer program product can also be distributed electronically.

The functionality described herein, both at the application server side and at the user side, can be implemented by one of ordinary skill in the art using software instructions of any suitable computer program language, such as, for example, JAVA, C++ or comparable language.

### REFERENCES CITED

All references cited herein are incorporated herein by reference in their entirety and for all purposes to the same extent as if each individual publication or patent or patent application was specifically and individually indicated to be incorporated by reference in its entirety herein for all purposes.

Many modifications and variations of this invention can be made without departing from its spirit and scope, as will be apparent to those skilled in the art. The specific embodiments described herein are offered by way of example only, and the invention is to be limited only by the terms of the appended claims, along with the full scope of equivalents to which such claims are entitled.

What is claimed:

1. A computer program product for use in conjunction with a computer system, the computer program product comprising a computer readable storage medium and a computer program mechanism embedded therein for providing medical reference information to a user, the computer program mechanism comprising:
(A) instructions for receiving a search query;
(B) instructions for searching data using said search query, wherein said data is organized into a plurality of therapeutic categories, each respective therapeutic category in the plurality of therapeutic categories comprising a plurality of documents that relate to the respective therapeutic category, each document in the data organized into a plurality of predetermined fields of information, wherein each document in the data is associated with a single therapeutic category in the plurality of therapeutic categories, wherein the instructions for searching data comprises the method of:
(i) identifying a subset of the plurality of therapeutic categories that pertain to the search query;
(ii) identifying a subset of documents that pertain to the search query; and
(iii) identifying a subset of fields of information contained in documents in the data that pertain to the search query; and
(C) instructions for separately outputting (i) said subset of the plurality of therapeutic categories, (ii) a listing of said subset of documents that pertain to the search query, and (iii) said subset of fields of information that pertain to the search query to a user, a display, a user-accessible computer readable media, or a computer.

2. The computer program product of claim 1, wherein the instructions for separately outputting further comprising ranking said subset of documents based on relevance to the search query and displaying said subset of documents ranked based on relevance to the search query.

3. The computer program product of claim 1, wherein the data is trusted health care reference information and each document in the data is a monograph pertaining to a therapeutic category in the plurality of therapeutic categories.

4. The computer program product of claim 3, wherein a monograph in the data describes a drug that is used to treat a disease.

5. The computer program product of claim 3, wherein a monograph in the data describes a disease.

6. The computer program product of claim 1, wherein the plurality of predetermined fields of information comprises at least five fields from the group consisting of an introduction field, a summary field, a pharmacology field, a pharmaco-kinetics field, an Food and Drug Administration (FDA) approved indications field, an off-label uses field, a dosage and administration field, an adverse effects field, an overdose field, a safety data field, a contraindications field, a warnings field, a precautions field, a drug interactions field, an efficacy measures field, a cost comparison field, a clinical trials field, a conclusions field, a recommendations field, a references field, and a research summaries field.

7. The computer program product of claim 1, wherein the plurality of predetermined fields of information comprises at least eight fields from the group consisting of an introduction field, a summary field, a pharmacology field, a pharmaco-kinetics field, an Food and Drug Administration (FDA) approved indications field, an off-label uses field, a dosage and administration field, an adverse effects field, an overdose field, a safety data field, a contraindications field, a warnings field, a precautions field, a drug interactions field, an efficacy measures field, a cost comparison field, a clinical trials field, a conclusions field, a recommendations field, a references field, and a research summaries field.

8. The computer program product of claim 1, wherein the identifying a subset of documents that pertain to the search query comprises scoring each respective document in the data for a number of occurrences of the search term in the respective document thereby obtaining a document score, wherein an instance of the search term in a header of the respective document is given more weight in the document score than an instance of the search term in the body of the respective document.

9. The computer program product of claim 1, wherein each document in the subset of documents is in a therapeutic category in the plurality of therapeutic categories.

10. The computer program product of claim 1, wherein a document in the subset of documents is not in a therapeutic category in the plurality of therapeutic categories.

11. A computer system comprising:
a processor; and
a memory, coupled to the processor, the memory storing:
(A) instructions for receiving a search query;
(B) instructions for searching data using said search query, wherein said data is organized into a plurality of therapeutic categories, each respective therapeutic category in the plurality of therapeutic categories comprising a plurality of documents that relate to the respective therapeutic category, each document in the data organized into a plurality of predetermined fields of information, wherein each document in the data is associated with a single therapeutic category in the plurality of therapeutic categories, wherein the instructions for searching data comprises the method of:
(i) identifying a subset of the plurality of therapeutic categories that pertain to the search query;
(ii) identifying a subset of documents that pertain to the search query; and
(iii) identifying a subset of fields of information contained in documents in the data that pertain to the search query; and
(C) instructions for separately outputting (i) said subset of the plurality of therapeutic categories, (ii) a listing of said subset of documents that pertain to the search query, and (iii) said subset of fields of information that pertain to the search query to a user, a display, a user-accessible computer readable media, or a computer.

12. The computer of claim 11, wherein the instructions for separately outputting further comprising ranking said subset of documents based on relevance to the search query and displaying said subset of documents ranked based on relevance to the search query.

13. The computer of claim 11, wherein the data is trusted health care reference information and each document in the data is a monograph pertaining to a therapeutic category in the plurality of therapeutic categories.

14. The computer of claim 13, wherein a monograph in the data describes a drug that is used to treat a disease.

15. The computer of claim 13, wherein a monograph in the data describes a disease.

16. The computer of claim 11, wherein the plurality of predetermined fields of information comprises at least five fields from the group consisting of an introduction field, a summary field, a pharmacology field, a pharmaco-kinetics field, an Food and Drug Administration (FDA) approved indications field, an off-label uses field, a dosage and administration field, an adverse effects field, an overdose field, a safety data field, a contraindications field, a warnings field, a precautions field, a drug interactions field, an efficacy measures field, a cost comparison field, a clinical trials field, a conclusions field, a recommendations field, a references field, and a research summaries field.

17. The computer program product of claim 11, wherein the identifying a subset of documents that pertain to the search query comprises scoring each respective document in the data for a number of occurrences of the search term in the respective document thereby obtaining a document score, wherein an instance of the search term in a header of the respective document is given more weight in the document score than an instance of the search term in the body of the respective document.

18. The computer program product of claim 11, wherein each document in the subset of documents is in a therapeutic category in the plurality of therapeutic categories.

19. The computer program product of claim 11, wherein a document in the subset of documents is not in a therapeutic category in the plurality of therapeutic categories.

20. A method comprising:
(A) receiving a search query;
(B) searching data using said search query, wherein said data is organized into a plurality of therapeutic categories, each respective therapeutic category in the plurality of therapeutic categories comprising a plurality of documents that relate to the respective therapeutic category, each document in the data organized into a plurality of predetermined fields of information, wherein each document in the data is associated with a single therapeutic category in the plurality of therapeutic categories, wherein the instructions for searching data comprises the method of:
(i) identifying a subset of the plurality of therapeutic categories that pertain to the search query;
(ii) identifying a subset of documents that pertain to the search query; and
(iii) identifying a subset of fields of information contained in documents in the data that pertain to the search query; and
(C) separately outputting (i) said subset of the plurality of therapeutic categories, (ii) a listing of said subset of documents that pertain to the search query, and (iii) said subset of fields of information that pertain to the search query to a user, a display, a user-accessible computer readable media, or a computer.
